(19) United States
(12) Patent Application Publication
(10) Pub. No.: US 2007/0042183 A1
(43) Pub. Date: Feb. 22, 2007

(54) Carrier for aqueous media

(75) Inventors: Hartmut Stenzel, Obernburg (DE); Erich Kessler, Odenwald (DE); Quang Huang, Obernburg (DE)

Correspondence Address: Hammer & Hanf, Suite G, 3125 Springbank Lane, Charlotte, NC, 28226, US

(73) Assignee: MEMBRANA GMBH, Wuppertal (DE)

(21) Appl. No.: 10/560,468

(22) PCT Filed: Jun. 23, 2004
(86) PCT No.: PCT/EP04/06761

§ 371 Date: Nov. 7, 2006

(30) Foreign Application Priority Data
Jul. 3, 2003 (DE) 103 30 190.9

(51) Int. Cl. B32B 9/00

(52) U.S. Cl. 428/402.2

(57) ABSTRACT

The invention relates to a carrier in the form of particles, which can be loaded with aqueous media. Said particles are formed from a porous hydrophobic polymer substrate, have an average particle size ranging between 50 ?m and 5000 ?m, and are provided with an at least partly open-pore structure having an average pore diameter ranging between 1 ?m and 200 ?m. The inventive carrier can be loaded with 10 to 95 percent by weight of water relative to the total weight of the loaded carrier, said loadability being determined by contacting the carrier with water. Also disclosed is a storage device which is based on said carrier and is loaded with an aqueous medium. The invention further relates to a method for producing such a carrier in the form of particles that are based on a hydrophobic polymer, said carrier being loadable with 10 to 95 percent by weight of water. According to said method, the polymer substrate that is provided in particles is hydrophilized on at least one portion of the entire surface thereof, which comprises the exterior surface and the surface of the pores thereof.

The invention relates to a carrier for aqueous media and a method for producing carriers of this type for aqueous media.

In a number of applications, a need exists for particulate carriers that can absorb water or, in general, aqueous media, and store these if required by the application.

In plastics processing, for example, it is frequently necessary to mix solid or liquid additives in small concentrations into a polymer melt. Such additives may be, for example, antioxidants, plasticisers, fragrances, slip agents, antistatic agents, surface-active substances, and the like. A masterbatch process is often used for this purpose, whereby a concentrate of the additive to be blended in is first produced in a suitable polymer and this concentrate is then blended into a polymer melt by, for example, an extrusion process, with homogeneous distribution of the additive. Masterbatches of this type are frequently produced using porous particulate polymer structures, the additive being introduced into the pores.

DE 27 37 745 C2 describes microporous polymer structures produced by a process involving thermally induced phase separation from a homogeneous melt of the polymer and an organic liquid compatible with the polymer. Firstly, the method of DE 27 37 745 C2 allows production of structures that contain additives as functionally active liquids, whereby the functionally active liquids are simultaneously the compatible organic liquid used in the production of the polymer structures, the liquid remaining in at least part of the pore system after formation of the porous polymer structure. Secondly, the method of DE 27 37 745 C2 allows production of unfilled microporous structures into whose pore systems additives in organic solution can subsequently be introduced via absorption mechanisms. Similar structures that can be loaded with additives can also be produced by the method described in DE 32 05 289 C2.

WO 98/55540 describes porous polymer particles based on polyolefins. These polymer particles can be loaded with, for example, liquid additives by absorption mechanisms. However, for loading of hydrophobic polymer particles as disclosed in WO 98/55540, the additives must be hydrophobic additives. The hydrophobic porous polymer particles of WO 98/55540 are not capable of absorbing aqueous media.

A significant number of applications require hydrophobic polymers as carriers for additives or functional liquids, examples of such polymers being polyolefins such as polyethylene, polypropylene or poly(4-methyl-1-pentene), or fluoropolymers such as polyvinylidene fluoride or polyvinyl fluoride. Polymers of this type are distinguished by such properties as, for example, high chemical resistance and/or physiological safety, high mechanical stability and temperature stability. Moreover, in masterbatches used for, for example, incorporation into polyolefins, it is often necessary, for reasons of compatibility, to use additive concentrates based on the above-mentioned hydrophobic polymers. Porous polymer structures made from these polymers are on account of their hydrophobic properties easily loaded with hydrophobic functional liquids or with hydrophobic liquids containing additives.

A number of functional liquids or additives are however aqueous in nature. For example, many additives such as dispersions of latex particles, colour pigments, kaolin and nanoparticles exist in the first instance in the form of an aqueous dispersion or emulsion. Functional liquids or additive dispersions of this type can however be absorbed by currently known hydrophobic porous polymer particles only to a very small extent or not at all.

In the production of foams from thermoplastics, as for example in production of polyolefin foams, water is often used as a foaming agent. In this case also, as for the above-mentioned additives for plastics processing, the problem arises of homogeneous blending of the water in very low concentrations into the polymer melts, resulting in the need for suitable water-containing masterbatches. However, no water-storing concentrates can be produced using the currently known porous polymer structures such as those based on polyolefins.

Finally, the need exists also in, for example, air humidification and air conditioning for free-flowing materials containing large quantities of water and having a large surface area.

A number of products, termed superabsorbers, are known that are capable of functioning as carriers for aqueous media and absorbing many times their own weight in liquid, which they can retain even when subjected to the highest pressures. Such products are based on, for example, cellulosic polymers or on modified polyacrylates, polyacrylonitriles or polyvinyl alcohols, i.e. on hydrophilic polymers. The disadvantage of products of this type is that they often do not possess adequate mechanical stability and are not free flowing. Moreover they are not suitable for absorption of, for example, aqueous dispersions, and compatibility problems arise when such products are blended into hydrophobic thermoplastic polymers such as polyolefins.

It is therefore the object of the present invention to provide a carrier, based on a hydrophobic polymer, that can be loaded with aqueous media, that can absorb water or in general aqueous media and also store these if the application so demands, and that allows production of additive concentrates starting from aqueous additive dispersions. It is a further object of the present invention to provide a method for producing such carriers. Yet a further object is to provide a storage device, based on a hydrophobic polymer, for aqueous media.

The object is achieved by a carrier in the form of particles that can be loaded with aqueous media, wherein the particles are made of a porous, hydrophobic polymer substrate, have a mean particle size between 50 μm and 5000 μm, and possess at least in part an open-pore structure with mean pore diameter between 1 μm and 200 μm, the particulate carrier having a loadability with water, as determined by bringing it into contact with water, of 10 wt. % to 95 wt. % relative to the total weight of the loaded carrier.

The carrier of the invention therefore refers to porous polymer particles, based on a hydrophobic polymer substrate, that can be loaded with aqueous media. Because the carrier of the invention is in the form of particles, it is pourable and free flowing, which is particularly advantageous for further processing. In a preferred embodiment of the invention the porous polymer substrate is hydrophilised over at least part of its entire surface, comprising the outer surface and the surface of its pores. It is particularly advantageous if the porous polymer substrate is hydrophilised over essentially its entire surface, comprising the outer surface and the surface of its pores. This can be achieved with porous polymer substrates whose pore volume has a high proportion of accessible pores.

The object of the invention is further achieved by a method for production of a carrier, in the form of particles based on a hydrophobic polymer, that can be loaded with aqueous media, and having a loadability with water, as determined by bringing the carrier into contact with water, of 10 wt. % to 95 wt. % relative to the total weight of the loaded carrier, the method comprising the following steps:
selection of a porous hydrophobic polymer substrate in the form of particles, the polymer substrate having a mean particle size between 50 μm and 5000 μm and an at least partly open-pore structure with a mean pore diameter between 1 μm and 200 μm;
hydrophilisation of the particulate polymer substrate over at least part of its total surface, comprising the outer surface and the surface of its pores, to obtain the carrier loadable with aqueous media.

The method of the invention is particularly suitable for production of the carrier of the invention. Moreover, the method of the invention for production of a carrier loadable with aqueous media can also be extended to a method for production of a storage device loaded with aqueous media. A further object of the invention is therefore achieved by a method for production of a storage device, based on a hydrophobic polymer and loaded with an aqueous medium, comprising at least the steps of selection of a porous hydrophobic polymer substrate in the form of particles, the polymer substrate having a mean particle size between 50 μm and 5000 μm and an at least partly open-pore structure with a mean pore diameter between 1 μm and 200 μm; hydrophilisation of the particulate polymer substrate over at least part of its total surface, comprising the outer surface and the surface of its pores; and loading of the hydrophilised particulate polymer substrate with the aqueous medium to the extent of 10 wt. % to 95 wt. % relative to the total weight of the loaded storage device, by bringing the hydrophilised polymer substrate into contact with the aqueous medium.

From the carrier of the invention, or by means of the method described above, a storage device loaded with an aqueous medium and consisting of particles is therefore provided in accordance with the present invention, the storage device being loaded with the aqueous medium to between 10 wt. % and 95 wt. % relative to the total weight of the loaded storage device, whereby the particles are made up of a hydrophobic polymer substrate, have a mean particle size between 50 and 5000 μm, and possess an at least partly open-pore structure and a mean pore diameter between 1 μm and 200 μm.

The porous particulate hydrophobic polymer substrate used, with an at least partly open-pore structure, can have a sponge-like, cellular, or even a network- or coral-type microstructure. According to the invention, the pore structure must be at least partly open-pore, i.e. the pores present in the polymer substrate must be in fluid communication with one another in at least some regions of the substrate structure, and the particles of the polymer substrate must be open-pore in at least some regions of their external surface. This allows adequate permeability to aqueous media as well as the loadability with aqueous media required by the invention. The use of a particulate polymer substrate having at least partly open-pore structure and a mean pore size between 1 μm and 200 μm allows on the one hand absorption of water or aqueous media, and, on the other, fixation of the water or aqueous medium in the pore system of the carrier of the invention, so that this is excellently suited for use as the storage matrix of the invention for aqueous media. In a preferred embodiment, the polymer substrate used as in the invention has a mean pore diameter in the range of 5 μm to 100 μm. A mean pore diameter in the range of 5 μm to 50 μm is especially preferred. Carriers of the invention based on polymer substrates with such preferred pore diameters have good loadability as well as excellent capacity for storage of aqueous media, without any leakage of the aqueous medium from the carrier.

The porous particulate carriers of the invention are distinguished by high absorption capacity for aqueous media. The absorption capacity for aqueous media is assessed from the water absorption capacity on bringing the carrier of the invention into contact with water, firstly in regard to what is termed in the present invention as the loadability, i.e. the amount of water that can be absorbed by the particulate porous carrier of the invention, and secondly with the help of the characteristic loading time, i.e. the time required to fill the pore volume with water.

According to the invention the particulate carrier has a loadability with water of 10 wt. % to 95 wt. % relative to the total weight of the loaded carrier. In general the loadability increases with increasing volume porosity of the polymer substrate used. Similar remarks apply also in regard to loading of the storage device of the invention. The volume porosity of the polymer substrates used in accordance with the invention is conveniently between 15 vol. % and 95 vol. %. In a preferred embodiment of the invention, the polymer substrate has a porosity in the range between 30 vol. % and 90 vol. %. Carriers of the invention based on such polymer substrates preferably have a loadability with water of between 25 wt. % and 90 wt. %. A preferred storage device based on such a polymer substrate has a loadability of between 25 wt. % and 90 wt. %. Especially preferred are polymer substrates with a porosity between 50 vol. % and 85 vol. %. Carriers of the invention based on such especially preferred polymer substrates preferably have a loadability with water between 45 wt. % and 85 wt. %. Especially in this type of carrier of the invention, high loadability with water on the one hand and high mechanical stability on the other are realised, allowing unproblematic storage of carriers filled with aqueous media in, for example, containers or sacks without leakage of the aqueous medium from the particles. An especially preferred storage device based on the above-mentioned especially preferred polymer substrates has a loadability for the aqueous medium in the range between 45 wt. % and 85 wt. %.

In an advantageous embodiment, the particulate porous carriers of the invention have a characteristic loading time of 120 minutes at most, and especially preferably of 90 minutes at most.

With a view to rapid loadability and good flow behaviour of the carrier or storage device of the present invention, polymer substrates with a particle size between 50 μm and 5000 μm are preferred. Especially preferred are polymer substrates of particle size between 400 μm and 3000 μm. The particles of the polymer substrate, and therefore of the carrier or storage device of the invention, can have any desired shape. The particles of the polymer substrate can be spherical, oval, cylindrical or granular, or can possess any other regular or irregular shape.

For hydrophilisation the polymer substrate can be, for example, impregnated with a solution of a hydrophilic polymer. Polymers such as polyethylene glycols, polyethylene oxides, polyacrylamides, polyvinyl alcohols, etc. can be used as hydrophilic polymers for this purpose. It is also possible to coat the surface of the polymer substrate with polymerisable hydrophilic monomers, a radical initiator and a crosslinker, and crosslink the monomers into a hydrophilic layer on the surface.

Preferably, however, surfactants are used for hydrophilisation of the polymer substrate, i.e. in a preferred embodiment of the invention, the porous polymer substrate is hydrophilised by a coating of a surfactant. Accordingly, in the method of the invention the hydrophilisation is preferably performed by impregnating the polymer substrate over at least part of its total surface, comprising the external surfaces and the surface of its pores, with a solution of a surfactant in a volatile solvent or solvent mixture that is essentially inert to the polymer substrate and does not dissolve it to any significant extent.

In the context of the present invention, surfactants are understood to be substances whose molecules have at least one hydrophilic and one hydrophobic functional group, the hydrophilic and hydrophobic parts of the molecule being in equilibrium with each other, as a result of which the molecules are in a position to accumulate at interfaces of aqueous phases. Moreover, surfactants also have the ability to lower interfacial tension and to form what are known as micelles. In the context of the current invention it is advantageous that on account of the hydrophobic groups surfactants have a pronounced affinity for hydrophobic materials, so that good adsorption of the surfactants to the surface of the porous hydrophobic polymer substrates used in the invention, and therefore good coating with surfactants of the polymer substrates used in the invention, are possible. At the same time, the hydrophilic part of the surfactant molecules ensures the necessary pronounced affinity for aqueous media.

In the context of the present invention a volatile solvent or solvent mixture is understood to be a solvent or solvent mixture whose boiling point lies below the boiling point or decomposition temperature of the surfactant used. The boiling point of the solvent or solvent mixture preferably does not exceed 100° C.

The solvent or solvent mixture used in the invention to produce the surfactant solution is one that is essentially inert to the polymer substrate, i.e. that does not react chemically with the polymer substrate, or dissolve it, to any significant extent. In individual cases, however, some slight swelling of the polymer substrate under the influence of the solvent or solvent mixture may have to be tolerated.

For applications where in aqueous systems sufficiently stable coatings are required with good adhesion to the surfaces of the hydrophobic polymer substrate used, the surfactants used are water-insoluble surfactants that are incorporated into the polymer substrate by means of an organic solvent or solvent mixture.

It is naturally also possible, in accordance with the invention, to use water-soluble surfactants for hydrophilisation of the polymer substrate. In this case the porous carrier is directly impregnated with an aqueous surfactant solution.

This provides simultaneously a simple method for producing the storage device of the invention, loaded with an aqueous medium and based on a hydrophobic polymer, the method comprising the following steps:
selection of a porous, hydrophobic polymer substrate in the form of particles, the polymer substrate having a mean particle size between 50 μm and 5000 μm and an at least partly open-pore structure with a mean pore diameter between 1 μm and 200 μm;
direct loading of the hydrophobic polymer substrate with the aqueous medium to the extent of 10 wt. % to 95 wt. % relative to the total weight of the loaded storage device, by bringing the hydrophobic polymer substrate into contact with the aqueous medium, the latter containing a water-soluble surfactant.

The aqueous medium containing the water-soluble surfactant is therefore left in the polymer substrate, and a complex intermediate drying step that would otherwise be necessary is no longer required. The loaded polymer substrate directly represents the storage device of the invention.

Non-ionic, anionic or cationic surfactants can be used for hydrophilisation in accordance with the invention.

When non-ionic surfactants are used, the preferred surfactants are selected from the group of fatty-acid glycerides such as monoglycerides or diglycerides; polyglycol ether surfactants such as fatty alcohol polyglycol ethers, alkyl phenol polyglycol ethers, fatty acid polyglycol ethers, fatty acid amide polyglycol ethers; fatty acid glycol esters such as fatty acid ethylene glycol esters or fatty acid diethylene glycol esters; fatty acid mono-, di- or tri-esters of sorbitan; or fatty acid amides such as fatty acid monoethanolamide or fatty acid diethanolamide. Mixtures of different surfactants can also be used here. The most suitable are fatty acid glycerides, particularly good results being obtained with glycerol monooleate or glycerol monostearate.

If water-soluble non-ionic surfactants are used in the invention, assessment of the water solubility is possible using the HLB value.

The HLB (hydrophilic lipophilic balance) value expresses the ratio of the strength of the hydrophilic part to that of the hydrophobic part of the molecule. It is a measure of the water- or oil-solubility of predominantly non-ionic surfactants, and of the stability of emulsions. The HLB value of a surfactant is calculated additively from all parts of the amphiphile molecule. It reflects the type and number of the hydrophobic chains and hydrophilic groups. The values range in general between 1 and 20. HLB values of <7 characterise predominantly lipophilic molecules that dissolve more readily in oil. Surfactants with HLB values >7 are usually sufficiently soluble in water and can therefore be used as water-soluble non-ionic surfactants of the invention. However, when water-soluble non-ionic surfactants are used, those with an HLB value between 10 and 15 are preferred.

To ensure good adsorption of the non-ionic surfactant on the hydrophobic polymer, the hydrophobic part of the surfactant molecule should be made up of a chain of 10 to 30 carbon atoms. In a preferred embodiment of the invention, the hydrophobic part of the surfactant molecule consists of a chain of 10 to 20 carbon atoms. The use of surfactant molecules in which the hydrophobic part consists of a chain of 10 to 15 carbon atoms has proved to be most satisfactory. If water-soluble non-ionic surfactants are used, the HLB value should lie between 10 and 15.

When water-soluble surfactants are involved, not only ionic surfactants can be used but those from the group of non-ionic surfactants as well. Commercially available ionic surfactants of both anionic and cationic types are predominantly water soluble.

Anionic surfactants with one or more functional anionic groups dissociate in aqueous solution with formation of anions, which are ultimately responsible for the surface-active properties. Examples of typical anionic groups are —COONa, —SO₃Na and —OSO₃Na. Particularly suitable anionic surfactants are those selected from the group of soaps, alkyl sulfates, alkane sulfonates, alkyl aryl sulfonates (e.g. dodecyl benzene sulfonate) or alkyl benzene sulfonates, α-olefin sulfonates, fatty alcohol sulfonates, fatty alcohol ether sulfonates and dialkyl sulfosuccinates.

In the case of the cationic surfactants, the high molecular weight hydrophobic residue determining the surface activity is found in the cation on dissociation in aqueous solution. Cationic surfactants that have been successfully used are quaternary ammonium compounds having the general formula (R₄N⁺)X⁻. These include, preferably, distearyl dimethyl ammonium chloride, palmityl trimethyl ammonium chloride, and cocobenzyl dimethyl ammonium chloride.

It is advantageous if the concentration of the surfactant in the particulate carrier of the invention or in the storage matrix of the invention lies between 0.1 wt. % and 15 wt. %, and especially preferably between 1 wt. % and 10 wt. %. Very good results are obtained when the concentration lies between 3 wt. % and 10 wt. %. The concentration must be chosen as a function of the porosity of the porous polymer substrate used, such that, on the one hand, adequate hydrophilisation is attained and, on the other, blocking, i.e. clogging, of the pores by their being coated with the surfactant is avoided. The hydrophilised polymer substrate, and therefore the carrier of the invention, preferably have the same porous configuration as the uncoated polymer substrate. Hydrophilisation is therefore preferably carried out in such a way that the porous structure of the polymer substrate is not essentially changed by the hydrophilisation, i.e. the pores of the polymer substrate are not blocked. For production of the carrier or storage device of the invention with a suitable concentration of surfactant, the concentration of the surfactant in the solution is preferably 1 wt. % to 10 wt. % in the method of the invention.

For wetting of the employed polymer substrate with the surfactant solution, particularly when water-insoluble surfactants are used to produce the surfactant solution, an organic solvent or solvent mixture is conveniently used. When water-soluble surfactants are used to produce the surfactant solution, water is conveniently used as the solvent.

An organic solvent or solvent mixture can also be understood to mean one that contains a proportion of water, provided that preparation of a homogeneous solution of the surfactants used is possible below the boiling point of the solvent or solvent mixture, preferably at temperatures in the range between 60° C. and 70° C., and the polymer substrate is well wetted by the solution so that impregnation of the polymer substrate with the surfactant solution can occur. The organic solvent or solvent mixture is especially preferably selected from the group of alcohols, ketones or esters, or mixtures of these substances. As stated above, alcohol/water mixtures, for example, can also be used.

Various methods are available for impregnation of the polymer substrate with the surfactant solution. A preferred method consists in immersing the polymer substrate in the surfactant solution for a sufficiently long period, to impregnate the entire accessible surface if possible. An ultrasound bath can be used, or a vacuum applied, to assist the impregnation process.

To remove the solvent or solvent mixture used to produce the carrier of the invention, the polymer substrate is dried after impregnation with the surfactant solution. This drying can be done at elevated temperatures and/or under vacuum. Drying temperatures must be selected so that the surfactant does not evaporate and is not decomposed during the drying process. Dielectric drying, e.g. by means of microwaves, is also possible.

According to the invention, it is preferable to use hydrophobic polymer substrates made from polymers or polymer blends from the group of polyolefins, fluoropolymers, styrene polymers, or a copolymer of these polymers. Particularly advantageously used polyolefins are polyethylene, i.e. HDPE, LDPE, LLDPE and UHMWPE, polypropylene, poly(4-methyl-1-pentene), poly(1-butene) and polyisobutene, and, as copolymers, ethylene propylene copolymer and ethylene vinyl acetate copolymer. Particularly preferred fluoropolymers are polyvinylidene fluoride and polyvinyl fluoride as well as the copolymers poly(tetrafluoroethylene-co-hexafluoropropylene), poly(tetrafluoroethylene-co-perfluoroalkyl vinyl ether) and poly(ethylene-co-tetrafluoroethylene). Particularly suitable styrene polymers are polystyrene and styrene acrylonitrile copolymers, styrene butadiene copolymers and acrylonitrile butadiene styrene copolymers. Especially preferred are polymer substrates based on polyolefins and particularly those based on polypropylene or polyethylene.

The polymers or polymer blends constituting the hydrophobic polymer substrates can contain additives such as antioxidants, nucleating agents, fillers, UV absorbers, etc. to selectively modify the properties of the substrates. The concentration of such additives is usually lower than 10 wt. % and preferably lower than 2 wt. %.

The particulate, polymeric, aqueous-media carriers of the invention are excellently suitable for production of polymer particles loaded with aqueous media, i.e. for production of a storage device for aqueous media. For example, polymer structures can be produced that contain a high proportion of water and can be used for such applications as foaming of thermoplastic polymers, or as a substrate for air conditioning and/or regulation of atmospheric humidity. The production of masterbatches with additives that, for example, are initially available as dispersions is also readily possible using the particulate polymeric carriers of the invention, by first filling a particulate polymeric carrier with a sufficient quantity of the aqueous dispersion and then removing the water by drying so that the solid fraction remains in the pore structure.

The invention will now be illustrated in detail with the help of the following embodiment examples. In these examples the following characterisation methods have been used.

### DETERMINATION OF PARTICLE SIZE

The mean particle size is determined microscopically from a representative sample, by means of a micrometric eyepiece or a suitable image analysis method.

### DETERMINATION OF MEAN PORE SIZE

The mean pore size is determined by means of digitalised SEM micrographs of fracture patterns of the samples, analysed using appropriate image analysis software. The diameters of approx. 50 to 100 pores are measured in μm from a SEM micrograph. The associated mean pore diameter is calculated by averaging over the individual values.

### DETERMINATION OF VOLUME POROSITY

Volume porosity can be determined by methods that are known per se. A pycnometric method, for example, is suitable for determination of the volume porosity of the hydrophobic polymer substrate, using water as the non-wetting liquid. Volume porosity can also be determined by suitable intrusion methods such as mercury intrusion or intrusion of other appropriate liquids.

### DETERMINATION OF LOADABILITY AND CHARACTERISTIC LOADING TIME

The determination of loadability and characteristic loading time requires that the volume porosity of the material under investigation be known.

10 to 30 g of the material under investigation is weighed into a 500 ml flask. The quantity of water added to the sample, i.e. the volume of water to be added, is determined by the porosity of the sample and the pore volume of the initially weighed out sample. The pore volume of the sample can be calculated from the initial weight, the polymer density ρ_{polymer} and the porosity ε. In the first step, water is added in such a quantity that complete absorption of the water by the sample can be expected. The volume of water added corresponds to approx. 60% of the previously determined pore volume of the sample.

After the addition of water, the flask is connected to a suitable mixing device such as a rotary evaporator with a water bath maintained at 25° C. Mixing is then performed until the sample is dry on the outside and flows freely. The loading time from the start of mixing to complete absorption of the water is determined by means of a stopwatch.

The flask is then detached from the mixing device, and an additional quantity of water, corresponding to 5% of the pore volume, is added. Mixing is then resumed and the time taken for this quantity of water to be fully absorbed by the sample is measured. This process is repeated until sample is saturated with water, the quantity of water added each time corresponding to 5% of the pore volume. Saturation is defined as the state in which water can be observed on the walls of the flask, and/or the particles of the sample adhere to one another, even after a total loading period of 3 hours. The characteristic loading time is calculated as the sum of the individual loading times, as determined using the stopwatch, in which the quantity of water was in each case completely absorbed by the sample. The saturated sample is then reweighed and the total weight of water absorbed by the sample is determined by subtracting the initial weight of the sample.

The loadability of the carrier is obtained from the ratio, expressed as a percentage, of the total quantity of water absorbed by the sample to the weight of the saturated sample.

### EXAMPLE 1

A particulate porous polymer substrate made of polypropylene in the form of a granulate with a porosity of 78 vol. %, a mean pore size of 20 μm and a mean particle size of 3 mm×3 mm was used. This polymer substrate was loaded with a 5 wt. % solution of the non-ionic surfactant Synperonic PE/L 121, a copolymer of a polyethylene glycol and a polypropylene glycol (from the company Uniqema), in isopropyl alcohol. The quantities of surfactant solution, and therefore of surfactant, were selected so that after drying of the treated polymer substrate a particulate carrier with a surfactant concentration of 5 wt. % was obtained. At this surfactant concentration, the hydrophilised polymer substrate had essentially the same porous configuration as the hydrophobic starting polymer substrate.

The particulate porous carrier coated with surfactant had a loadability with water of 50 wt. % relative to the total weight of the loaded carrier, and a characteristic loading time of 90 min. The carrier loaded in this way simultaneously represents the storage device of the invention with a load of 50 wt. % relative to the total weight.

### EXAMPLE 2

The same porous polymer substrate was used as in Example 1, 15 g of the polymer substrate being loaded over a period of one hour with 45 g of a 5 wt. % solution of the non-ionic surfactant Synperonic PE/L 121 in isopropyl alcohol. After vacuum drying in a water-bath maintained at 70° C. a surfactant content of 13 wt. % was obtained.

The dried particulate porous carrier coated with surfactant had a loadability with water of 60 wt. % relative to the total weight of the loaded carrier, and a characteristic loading time of 75 minutes. The carrier loaded in this way simultaneously represents the storage device of the invention with a load of 60 wt. % relative to the total weight.

### EXAMPLE 3

The same porous polymer substrate was used as in Example 1. The polymer substrate was coated with the anionic surfactant AEROSOL® MA (sodium di(1,3-dimethylbutyl) sulfosuccinate, from the company Cytec) by the same procedure as in Example 1. The particulate porous carrier coated with AEROSOL® MA had a loadability with water of 60 wt. % relative to the total weight of the loaded carrier, and a characteristic loading time of 5 min. The carrier loaded in this way simultaneously represents the storage device of the invention with a load of 60 wt. % relative to the total weight.

### EXAMPLE 4

A microporous HDPE granulate with a porosity of 65 vol. %, a mean pore size of 15 μm and a mean particle size of 3 mm×3 mm was used as the porous particulate polymer substrate. The HDPE polymer substrate was coated on its pore surface and external surface with 5 wt. % of glycerol monooleate by the procedure described in Example 1. The hydrophilised polymer substrate coated with glycerol monooleate thus had essentially the same porous configuration as the hydrophobic starting polymer substrate.

The particulate porous carrier so obtained had a loadability with water of 60 wt. % relative to the total weight of the loaded carrier, and a characteristic loading time of 100 min. The carrier loaded in this way simultaneously represents the storage device of the invention with a load of 60 wt. % relative to the total weight.

### EXAMPLE 5

The same porous polymer substrate was used as in Example 4. This polymer substrate was also loaded with a 5 wt. % solution of glycerol monooleate in isopropyl alcohol, 18 g of the polymer substrate being loaded with 42 g of the surfactant solution over one hour, so that after drying in vacuum in a water-bath maintained at 70° C. a surfactant content of 10.4 wt. % was obtained.

The particulate porous carrier coated with surfactant had a loadability with water of 65 wt. % relative to the total weight of the loaded carrier, and a characteristic loading time of 90 min. The carrier loaded in this way simultaneously represents the storage device of the invention with a load of 65 wt. % relative to the total weight.

### EXAMPLE 6

The same HDPE polymer substrate was used as in Example 3, and was coated on its pore surface and external surface with the non-ionic surfactant Span® 80 (sorbitan monooleate, from Merck) by the procedure described in Example 1.

A porous carrier with loadability with water of 50 wt. % relative to the total weight of the loaded carrier and a characteristic loading time of 60 min. was obtained. The carrier loaded in this way simultaneously represents the storage device of the invention with a load of 50 wt. % relative to the total weight.

### EXAMPLE 7

The HDPE granulate of Example 4 was used here as the particulate polymer substrate. This polymer substrate was loaded with a 5 wt. % solution of the non-ionic surfactant Span® 80 in isopropyl alcohol, 18 g of the polymer substrate being loaded with 42 g of the surfactant solution over one hour. After drying in vacuum in a water-bath maintained at 70° C. a surfactant content of 10.4 wt. % was obtained.

The dried particulate porous carrier coated with surfactant had a loadability with water of 65 wt. % relative to the total weight of the loaded carrier, and a characteristic loading time of 120 min. The carrier loaded in this way simultaneously represents the storage device of the invention with a load of 65 wt. % relative to the total weight.

### EXAMPLE 8

The same porous particulate polymer substrate was used as in Examples 4-7. This polymer substrate was impregnated with the water-soluble anionic surfactant ARMA (sodium di(1,3-dimethylbutyl)sulfosuccinate, from CYTEC Industries Inc., USA). An aqueous surfactant solution with a surfactant content of 5 wt. % was used, 20 g of the polymer substrate being loaded with 30 g of the surfactant solution. This product represented a particulate storage device loaded to 60 wt. % (relative to the total weight) with an aqueous medium.

The particulate polymer substrate loaded with the aqueous surfactant solution was then dried to investigate its reloadability with water. The dried, porous, particulate carrier coated with the surfactant had a loadability with water of 60 wt. % relative to the total weight of the loaded carrier, and a characteristic loading time of 35 minutes. The loaded carrier in turn represents the storage device of the invention with a load of 60 wt. % relative to the total weight.

### COMPARATIVE EXAMPLE 1

The polypropylene substrate used in Example 1 was tested without further treatment for its loadability with water. A volume of water was first added corresponding to only approx. 10% of the previously determined pore volume of the sample. Even after 3 hours the exterior of the test material was not dry, i.e. it had not absorbed any water. The untreated polypropylene substrate showed no loadability with water.

1. A carrier that can be loaded with an aqueous media comprises a plurality of particles, the particles being made of a porous hydrophobic polymer substrate, whereby the particles have a mean particle size between 50 μm and 5000 μm and an at least partly open-pore structure with a mean pore diameter between 1 μm and 200 μm, and whereby the particulate carrier has a loadability with water, determined by bringing it into contact with water, of 10 wt. % to 95 wt. % relative to the total weight of the loaded carrier.

2. The carrier according to claim 1, whereby the porous polymer substrate is hydrophilised over least part of its entire surface, the entire surface comprising the outer surfaces and the surface of its pores.

3. The carrier according to claim 1, whereby the porous polymer substrate is hydrophilised over essentially its entire surface, the entire surface comprising the outer surfaces and the surface of its pores.

4. The carrier according to claim 2, whereby the porous polymer substrate is hydrophilised by coating with a surfactant.

5. The carrier according to claim 4, whereby the surfactant is a non-ionic surfactant selected from the group consisting of fatty acid glycerides, polyglycol ethers, fatty acid glycol esters, fatty acid mono-, di- or triesters of sorbitan, and fatty acid amides.

6. The carrier according to claim 5, whereby the non-ionic surfactant is a fatty acid glyceride.

7. The carrier according to claim 5, whereby the non-ionic surfactant has an HLB value higher than 7.

8. The carrier according to claim 5, whereby the non-ionic surfactant has an HLB value of 10 to 15.

9. The carrier according to claim 4, whereby the surfactant is an anionic surfactant selected from the group of soaps, alkyl sulfates, alkane sulfonates, alkyl aryl sulfonates or alkyl benzene sulfonates, α-olefin sulfonates, fatty alcohol sulfonates, fatty alcohol ether sulfonates and dialkyl sulfosuccinates.

10. The carrier according to claim 4, whereby the surfactant is a cationic surfactant selected from the group of quaternary ammonium compounds.

11. The carrier according to claim 4, whereby the surfactant in the carrier has a concentration between 0.1 wt. % and 15 wt. % relative to the weight of the carrier.

12. The carrier according to claim 1, whereby the polymer of which the polymer substrate is selected from the group consisting of a polyolefin, a fluoropolymer, a styrene polymer, or a copolymer of these polymers.

13. The carrier according to claim 1, whereby the carrier possesses essentially the same porous configuration as the porous polymer substrate.

14. The carrier according to claim 1, whereby the carrier has a porosity in the range between 30 vol. % and 90 vol. %, and the loadability with water between 25 wt. % and 90 wt. % relative to the total weight of the loaded carrier.

15. The carrier according to claim 1, whereby the particles have a mean pore diameter in the range between 5 μm and 100 μm.

16. The carrier according to claim 1, whereby the carrier has a characteristic loading time for water of 120 minutes at most.

17. The carrier according to claim 1, whereby the carrier has a characteristic loading time for water of 90 minutes at most.

18. A method for production of a carrier loadable with aqueous media and in a form of particles based on a hydrophobic polymer, the carrier having a loadability with water, as determined by bringing the carrier into contact with water, of 10 wt. % to 95 wt. % relative to the total weight of the loaded carrier, comprising the steps of:
selecting a porous hydrophobic polymer substrate in the form of particles, the polymer substrate having a mean particle size between 50 μm and 5000 μm and an at least partly open-pore structure with a mean pore diameter between 1 μm and 200 μm;
hydrophilising the particulate polymer substrate over at least part of its total surface, the total surface comprising the outer surface and the surface of its pores, to obtain the carrier loadable with aqueous media.

19. The method according to claim 18, whereby the carrier loadable with aqueous media possesses essentially the same porous configuration as the hydrophobic polymer substrate.

20. The method according to claim 18, whereby the polymer substrate for hydrophilisation is impregnated over at least part of its total surface, the total surface comprising the outer surface and the surface of its pores, with a solution of a surfactant in a volatile solvent or solvent mixture that is essentially inert to the polymer substrate and does not dissolve the polymer substrate to any significant extent.

21. The method according to claim 20, whereby the solvent or solvent mixture has a boiling point not exceeding 100° C.

22. The method according to claim 20, whereby an organic solvent or solvent mixture is used as the solvent or solvent mixture.

23. The method according to claim 22, whereby the solvent or solvent mixture is selected from the group consisting of alcohols, ketones and esters.

24. The method according to claim 20, whereby the surfactant being a non-ionic surfactant selected from the group of fatty acid glycerides is used for the hydrophilisation.

25. The method according to claim 20, whereby the solvent is water.

26. The method according to claim 25, whereby the solvent is a water-soluble, non-ionic surfactant with an HLB value higher than 7.

27. The method according to claim 20, whereby the surfactant in the solution has a concentration between 1 wt. % and 10 wt. %.

28. The method according to claim 18, whereby the polymer substrate is made from a polymer selected from the group consisting of polyolefin, a fluoropolymer, a styrene polymer, or a copolymer of these polymers.

29. The method according to claim 18, whereby the polymer substrate has a mean pore diameter in the range between 5 μm and 100 μm.

30. The method according to claim 18, whereby the polymer substrate has a volume porosity between 30 vol. % and 90 vol. %.

31. Method for production of a storage device loaded with an aqueous medium and based on a hydrophobic polymer, comprising the steps of:
selecting a porous hydrophobic polymer substrate in the form of particles, the polymer substrate having a mean particle size between 50 μm and 5000 μm and an at least partly open-pore structure with a mean pore diameter between 1 μm and 200 μm,
hydrophilising the particulate polymer substrate over at least part of its total surface, the total surface comprising the outer surface and the surface of its pores, and
loading the hydrophilised particulate polymer substrate with the aqueous medium to the extent of 10 wt. % to 95 wt. % relative to the total weight of the loaded storage device, by bringing the hydrophilised polymer substrate into contact with the aqueous medium.

32. A method for producing a storage device loaded with an aqueous medium and based on a hydrophobic polymer, comprising the steps of:
selecting a porous hydrophobic polymer substrate in the form of particles, the polymer substrate having a mean particle size between 50 μm and 5000 μm and an at least partly open-pore structure with a mean pore diameter between 1 μm and 200 μm;
directly loading the hydrophobic polymer substrate with the aqueous medium to the extent of 10 wt. % to 95 wt. % relative to the total weight of the loaded storage device, by bringing the hydrophobic polymer substrate into contact with the aqueous medium, the latter containing a water-soluble surfactant.

33. A storage device consisting of particles loaded with an aqueous medium to the extent of 10 wt. % to 95 wt. % relative to the total weight of the loaded storage device, whereby the particles are made from a hydrophobic polymer substrate, have a mean particle size between 50 μm and 5000 μm, and possess an at least partly open-pore structure and a mean pore diameter between 1 μm and 200 μm.
